(19) United States
(12) Patent Application Publication
(10) Pub. No.: US 2022/0137721 A1
(43) Pub. Date: May 5, 2022

(54) POINTER LOCATING APPLETS

(71) Applicant: Hewlett-Packard Development Company, L.P., Spring, TX (US)

(72) Inventors: Lee Lim See, Taipei City (TW); Szu-Yi Chai, Taipei City (TW)

(73) Assignee: Hewlett-Packard Development Company, L.P., Spring, TX (US)

(21) Appl. No.: 17/419,756

(22) PCT Filed: Jul. 18, 2019
(86) PCT No.: PCT/US2019/042376

§ 371 Date: Jun. 30, 2021

(51) Int. Cl. G06F 3/038; G06F 3/0354; G06F 3/0481

(52) U.S. Cl. CPC G06F 3/038; G06F 2203/04801; G06F 3/0481; G06F 3/0354

(57) ABSTRACT

An example of an apparatus including a rendering engine to render an image to a display. The image includes a pointer. The apparatus further includes an input interface associated with the pointer to receive movement data. The apparatus also includes an analysis engine to process the movement data to determine whether the movement data represents a command to locate the pointer on the display. In addition, the apparatus includes an applet engine to execute an applet upon receiving the command The applet generates a pop-up window to provide a location of the pointer.

### BACKGROUND

Despite the proliferation of smaller portable electronic devices such as smartphones, tablets, and wearable devices, mid-size and larger electronic devices such as laptops and desktop systems remain popular. Such larger electronic devices typically have larger screens or multiple screens in some examples. The larger display area provides a user to view more windows and see more content over a wider area without switching between overlapping windows.

### BRIEF DESCRIPTION OF THE DRAWINGS

Reference will now be made, by way of example only, to the accompanying drawings in which:

FIG. 1 is a block diagram of an example apparatus to locate a pointer on a display screen of a personal computing device;

FIG. 2 is a flowchart of an example of a method of locating a pointer on a display screen of a personal computing device;

FIG. 3 is a block diagram of another example apparatus to locate a pointer on a display screen of a personal computing device;

FIG. 4A is a screenshot of the operation of the apparatus showing a pop-up window using a scaled version of the display;

FIG. 4B is a screenshot of the operation of the apparatus showing a pop-up window using a text based message on the display; and

FIG. 5 is a screenshot of the operation of the apparatus showing a pop-up window using a highlighting.

### DETAILED DESCRIPTION

As displays become larger and/or more complicated for personal computing systems, such as laptops, personal computers, and client terminals, more information may be displayed at higher resolutions. In addition, the displays are generally in color and may include features and images that may provide clutter. Such devices may also use a pointer input device as a source of user input. For example, pointer input devices may include a mouse, a trackball device, or a touchpad device. Pointer input devices typically receive input representing a motion. The input representing motion is then used to move a pointer displayed on a display screen of the personal computing system. As the pointer is moved over an interactive object on the display screen, such as a button or link, a user may provide input to activate the interactive object, such as via a button on the pointer input device, or other input. In some examples, moving the pointer on the display over the interactive object may automatically activate the object. Accordingly, the location of the pointer on a display screen is used to control many features of the personal computing systems. Therefore, it is to be appreciated that a user of the personal computing system may wish to know the location of the pointer on a display screen so that the user may direct the pointer to a desired interactive object.

In some cases when a display screen is cluttered with images or multiple windows with varied content, the pointer displayed on a display screen may be difficult to identify. This is especially true for situations where a user has left the pointer at a stationary location on the display and forgets where pointer location is. With a clutter screen, such as with a dense background, the pointer may be camouflaged and difficult to find. In some cases, even if the user moves the pointer on the display screen, the pointer may be difficult to identify through the camouflage.

An apparatus and method are provided to assist a user with locating a pointer on a display screen of the personal computing system. The apparatus may include a processor running an applet that opens a window to provide information relating to the location of the pointer. Accordingly, this may allow the user to readily identify the pointer on a display screen.

As used herein, any usage of terms that suggest an absolute orientation (e.g. “top”, “bottom”, “vertical”, “horizontal”, etc.) are for illustrative convenience and refer to the orientation shown in a particular figure. However, such terms are not to be construed in a limiting sense as it is contemplated that various components will, in practice, be utilized in orientations that are the same as, or different than those described or shown.

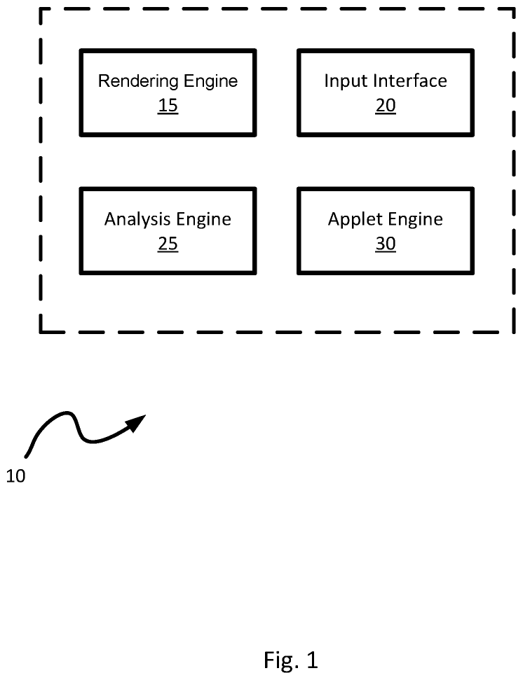

Referring to FIG. 1, an example apparatus to locate a pointer on a display screen of a personal computing device is generally shown at 10. The apparatus 10 may include additional components, such as various memory storage units, interfaces to communicate with other computer apparatus or devices, and input and output devices to interact with the user. In addition, input and output peripherals may be used to train or configure the apparatus 10 as described in greater detail below. In the present example, the apparatus 10 includes a rendering engine 15, an input interface 20, an analysis engine 25 and an applet engine 30. Although the present example shows the rendering engine 15, the analysis engine 25 and the applet engine 30 as separate components, in other examples, the rendering engine 15, the analysis engine 25 and the applet engine 30 may be part of the same physical component such as a microprocessor configured to carry out multiple functions.

It is to be appreciated that the apparatus 10 is not limited and may include a wide variety of devices capable of carrying out the functionality described below. For example, the apparatus 10 may be a desktop computer, a notebook or laptop computer, a tablet, a gaming counsel, or other smart device with a display screen. In some examples, the apparatus 10 may include multiple components such an example where the rendering engine 15, the analysis engine 25, and the applet engine 30 are operating in separate electronic devices connected by a network.

The rendering engine 15 is to receive image data and to render an image to be displayed on a display screen. In the present example, the image data includes a pointer, typically a white arrow or other image, for selecting interactive objects and/or navigating between application windows. The image data is not limited and may include data to display various application windows, applet windows, icons, menus, status indicators, and other features.

The manner by which the image is rendered is not particularly limited. For example, the image data may include images of various windows and features superimposed over the background image. The resulting image may be cluttered depending on the number of windows and features. In addition, during the operation of the personal computing system, it is to be appreciated that the image data may change. For example, as a user moves the pointer, the location of the pointer image will move to different coordinates on the display screen. Therefore, the rendering engine 15 may continuously render the image data. Since the majority of the image data may not change, such as when a user is active on a portion of the display screen, the rendering engine 15 may selective render portions of the image data and re-use other portions of the rendered data that have not changed.

The input interface 20 is to receive data from an input device. The source of the movement data is not limited and may include an input device connected to the personal computing system. The input device may be a pointer input device such as a mouse, trackball device, or touchpad. In other examples, the input device may also be a keyboard, a button on the personal computing system, a display, or standalone button to activate the apparatus 10 to locate the pointer.

In the present example, the input interface 20 is specifically to receive movement data associated with the pointer rendered on the display by the rendering engine 15. For example, the movement data may be from a user moving the mouse across a surface in an attempt to move the pointer on the display. For example, a user may move the pointer in a straight direction on the display screen, such as up, down, or to a side.

In the present example, the analysis engine 25 is to process the movement data received at the input interface 20. In particular, the analysis engine 25 is to determine whether the movement data is indicative of a user searching for the pointer on the display screen. If the movement data represents a user attempt to locate the pointer, the analysis engine 25 may generate a command to implement the apparatus 10 to assist the user in locating the point on the display screen. It is to be appreciated that movement data from a user may be intended and may not be a request for assistance with locating the pointer. For example, the user may be able to locate the pointer quickly without assistance in some cases. Accordingly, the movement data received may be movement data associate with an intended action of the user, such as switching application windows, interacting with a window or icon, or maneuvering to another portion of the display screen to interact with an interactive object, such as an icon.

The manner by which the analysis engine 25 determines whether the movement data represent a request or command to locate the pointer on the display screen is not limited. In an example, the analysis engine 25 may only process movement data after a predetermined period of inactivity has passed. The period of inactivity may represent a time where the user's attention is not focused on the display screen such that the user may forget where the pointer was last parked. Accordingly, movement after a period of inactivity may automatically be associated with a request to locate a pointer. In some examples, the inactivity may be complete inactivity at the personal computing system. In other examples, the inactivity may refer to inactivity associated with the pointer. In these examples, other activities, such as typing on a keyboard on the personal computing system, may occur. Accordingly, when the user returns to the using the pointer after being distracted with other activities, the user may be requesting assistance with locating the pointer via the movement data provided by the user. The length of the predetermined period of inactivity is not limited. In the present example, the predetermined period of inactivity may be about five minutes. In other examples, the predetermined period of inactivity may be longer, such as ten minutes, or shorter such as one minute or two minutes. Some examples may also have a varied predetermined period of activity which may be based on factors such as the number of applications open, the amount of clutter on the display screen, or the preferences and/or history of the user logged in to the session.

In other examples, the analysis engine 25 determines whether the movement data represents a command for assistance locating the pointer by analyzing the movement data. It is to be appreciated that in some instances, a user may have located the pointer and simply be moving the pointer intentionally to carry out an operation. Accordingly, the analysis engine may determine a pattern of pointer movement from the user and analyze the pattern to assess whether the pattern was represents a command to assist in locating the pointer or not. The factors considered in making the determination of whether the movement data represent a command to assist with locating the pointer. For example, the randomness of the movement data may indicate that the user is attempting to notice the motion of the pointer. Accordingly, if the movement data appears to change directions rapidly without a clear direction to indicate an intended target for the pointer, the analysis engine 25 may determine that the user is attempting to locate the pointer and generate the command.

In further examples, the analysis engine 25 may recognized predefined commands from the user for assistance in locating the pointer. The predefined commands are not limited an may involve predefined patterns of movements of the point received from the pointer input device. An example of a predefined movement, the analysis engine 25 may recognize a circular motion of the pointer as a command to provide assistance with locating the pointer. As another example, a back and forth motion, also referred to as a linear oscillation motion, may be recognized as a command to provide assistance with locating the pointer. In further examples, the predefined command may be a series of button presses or other input. The input may be from additional devices as well, such as a keyboard, monitor, or standalone input device.

The applet engine 30 is to execute an applet upon a determination by the analysis engine 25 that a command for assistance in locating the pointer is received. The applet executed by the applet engine 30 is not particularly limited and is to assist in locating the pointer on a display screen. In the present example, the applet generates a pop-up window to provide the location of the pointer.

The manner by which the applet provides the location is not limited. For example, the pop-up window may include a scaled down version of the display are present to the user where the point location is identified in the scaled version. It is to be appreciated that this is useful for personal computing devices having large a display screen or multiple display screens. By providing the information on a small pop-up window, the user would have less area to scan. In addition, the pop-up window may present the location of the pointer on a uniform background. Accordingly, the pointer is not able to camouflage with any other images on the display screen making it easier for the user to spot the approximate location. Once the approximate location of the pointer has been spotted by the user in the pop-up window, the user may then look for the pointer on the display screen in a narrow search area.

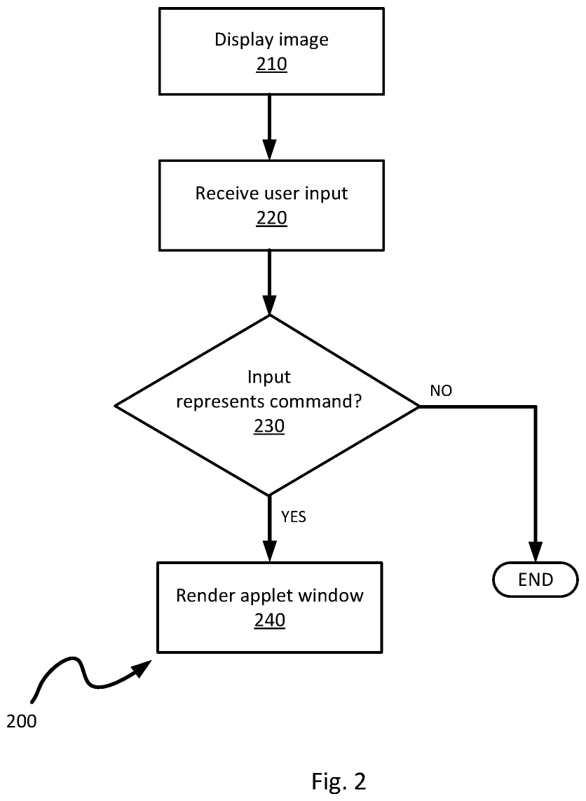

Referring to FIG. 2, a flowchart of an example method of locating a pointer on a display screen of a personal computing device is generally shown at 200. In order to assist in the explanation of method 200, it will be assumed that method 200 may be performed with the apparatus 10. Indeed, the method 200 may be one way in which apparatus 10 may be configured. Furthermore, the following discussion of method 200 may lead to a further understanding of the apparatus 10 and its various parts. In addition, it is to be emphasized, that method 200 may not be performed in the exact sequence as shown, and various blocks may be performed in parallel rather than in sequence, or in a different sequence altogether.

Block 210 involves displaying an image on a display screen with a pointer at some location. In the present example, the pointer is to blend with the background on the display screen. The blending of the pointer is not limited and may arise inherently from the background of the display screen. For example, the image displayed may include an image in the background having features that may appear similar to the pointer. For example, if the pointer rendered in the display screen is a small white arrow with a black outline, the background image may include a light colored object with numerous black lines in no particular pattern. Accordingly, when the pointer is positioned above this background image, the pointer may be difficult to distinguish by the human eye. It is to be appreciated that other images displaying varying objects in a dense matter may be able to camouflage the pointer without having a similar color scheme.

Next, at block 220, user input is received from a pointer input device. The user input is not particularly limited and may be movement data associated with the pointer. For example, the movement data may be from a user moving the mouse across a surface in an attempt to move the pointer on the display. In another example, the pointer input device may be a trackball device or where the movement data may be from a user rolling a ball. The trajectory of the motion is also not limited and the user may move the pointer in any direction or combinations of directions.

In the present example, block 220 may receive the user input in cases were a predetermined period of inactivity has passed. The period of inactivity may represent a time where the user's attention is not focused on the display screen such that the user may forget where the pointer was last parked. Accordingly, movement after a period of inactivity may automatically be associated with a request to locate a pointer. In some examples, the inactivity may be complete inactivity at the personal computing system. In other examples, the inactivity may refer to inactivity associated with the pointer. In these examples, other activities, such as typing on a keyboard on the personal computing system, may occur during the period of inactivity.

Block 230 involves determining whether the input received at block 220 represents a command to locate the pointer on the display over a background image with which the pointer blends. The manner by which the determination is made is not particularly limited. For example, the analysis engine 25 may determine whether the input received at block 220 by identifying a pattern in the movements of the pointer. For example, the pattern recognized may be a predefined pattern of pointer movement such as a circular motion. In other examples, the pattern may be in the form of another shape, a character, or random movements. If the analysis engine 25 determines that the user input received at block 220 is not a command, the method 200 ends. By contrast, if the analysis engine 25 determines that the user input received at block 220 is a command, the method 200 proceeds to block 240.

In block 240, the rendering engine 15 is to render an applet window. In the present example, the applet window is a pop-up window that may be generated upon receiving the command. In the present example, the pop-up window also provides the location of the pointer on the display screen.

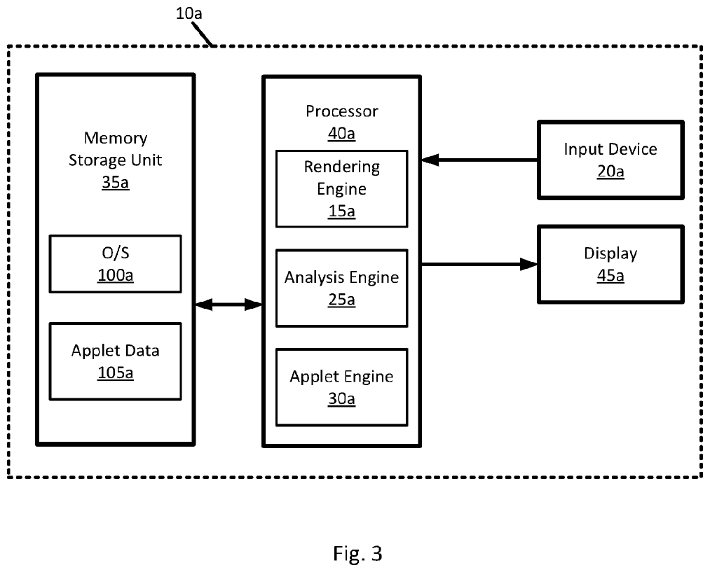

Referring to FIG. 3, another example of an apparatus to locate a pointer on a display screen of a personal computing device is shown at 10a. Like components of the apparatus 10a bear like reference to their counterparts in the apparatus 10, except followed by the suffix “a”. The apparatus 10a includes an input device 20a, a memory storage unit 35a, and a processor 40a.

In the present example, the input device 20a is not limited and may include any device for a user to move the pointer on the display. For example, the input device 20a may include a mouse, a trackball device, or a touchpad device to receive pointer input. In the present example, pointer input devices typically receive input representing a motion which may be used to move the pointer.

The memory storage unit 35a includes an operating system 100a that is executable by the processor 40a to provide general functionality to the apparatus 10a, for example, functionality to support various applications. Examples of operating systems include Windows™, macOS™, iOS™, Android™, Linux™, and Unix™. The memory storage unit 35a may additionally store instructions to operate the driver level as well as other hardware drivers to communicate with other components and other peripheral devices of the apparatus 10a, such as the input device 20a and the display 45a or various other output and input devices (not shown). Furthermore, the memory storage unit 35a may also instructions 105a to be executed out by the processor 40a.

In the present example, the processor 40a is not limited and may include a central processing unit (CPU), a graphics processing unit (GPU), a microcontroller, a microprocessor, a processing core, a field-programmable gate array (FPGA), an application-specific integrated circuit (ASIC), or similar. In other examples, the processor 40a may refer to multiple devices or combinations of devices capable of carrying out various functions. In the present example, the processor 40a is to operate the rendering engine 15a, the analysis engine 25a and the applet engine 30a.

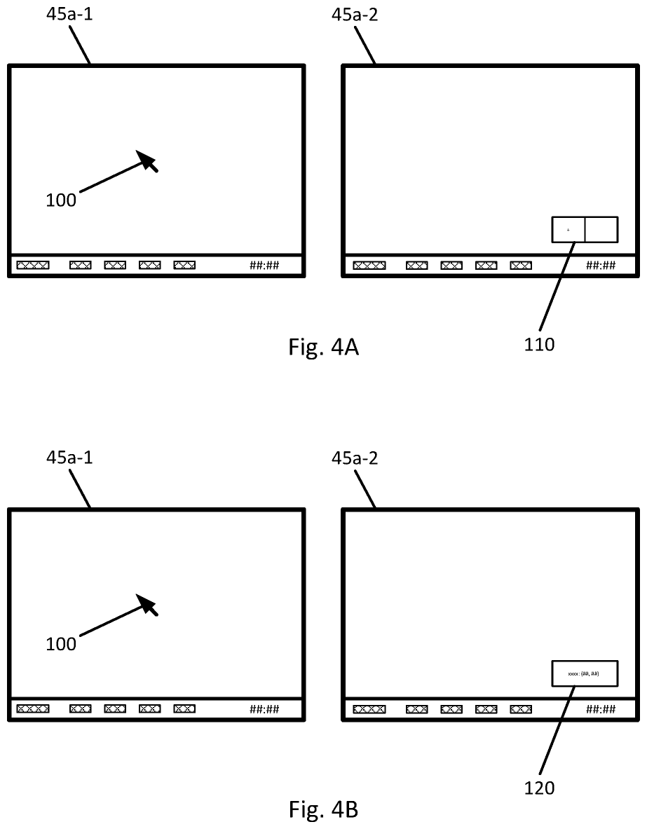

Referring to FIG. 4A, the display screens 45a-1 and 45a-2 of the apparatus 10a is operating on a personal computing system having two display screens 45a-1 and 45a-2. In this example, if the pointer 100 is to be located, the user may use the applet pop-up window 110 to locate the pointer. the manner by which the applet pop-up window 110 assists in the locating of the pointer 100 is not limited. For example, the applet pop-up window 110 may illustrate a scaled down version of the two display screens 45a-1 and 45a-2 to show the location of the pointer 100 is substantially in the center of the so that the user would have less are to scan.

Referring to FIG. 4B, the display screens 45a-1 and 45a-2 of the apparatus 10a is also shown in operation using a different applet from the one used in FIG. 4A. In the present example, the apparatus 10a is operating on a personal computing system having two display screens 45a-1 and 45a-2. In this example, if the pointer 100 is to be located, the user may use the applet pop-up window 120 to locate the pointer. The manner by which the applet pop-up window 120 assists in the locating of the pointer 100 is not limited. For example, the applet pop-up window 120 may generate text based information, such as the coordinates to aid in the location of the pointer.

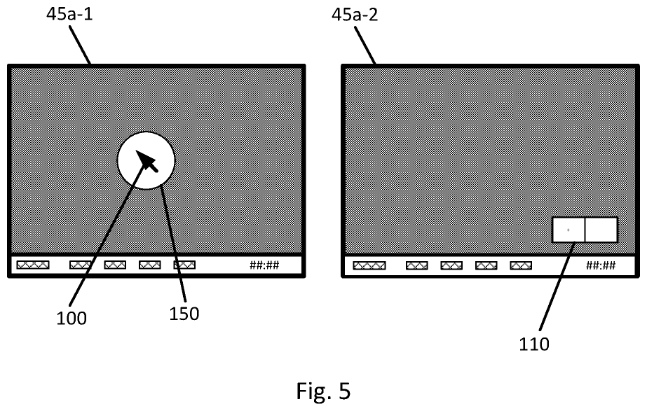

Referring to FIG. 5, the display screens 45a-1 and 45a-2 of the apparatus 10a is shown in operation. In the present example, the apparatus 10a is operating on a personal computing system having two display screens 45a-1 and 45a-2. In this example, if the pointer 100 is to be located, the rendering engine 15 may generate a highlighted area 150 to help locate the pointer 100. The manner by which the pointer is highlighted is not limited and may include changing the contrast or brightness of a region surrounding the pointer 100. In the present example, the brightness of the highlighted area 150 may be increased to draw the attention of the user to the highlighted area 150. To further assist with the locating of the pointer 100, the rendering engine may decrease the brightness outside of the highlighted area 150 and thus increase the contrast of the images around the highlighted area 150.

It should be recognized that features and aspects of the various examples provided above may be combined into further examples that also fall within the scope of the present disclosure.

What is claimed is:

1. An apparatus comprising:
a rendering engine to render an image to a display, wherein the image includes a pointer;
an input interface associated with the pointer to receive movement data;
an analysis engine to process the movement data to determine whether the movement data represents a command to locate the pointer on the display; and
an applet engine to execute an applet upon receiving the command, wherein the applet generates a pop-up window to provide a location of the pointer.

2. The apparatus of claim 1, wherein the analysis engine is to process the movement data to determine whether a pattern of pointer movement represents the command.

3. The apparatus of claim 2, wherein the pattern of pointer movement is a circular motion.

4. The apparatus of claim 2, wherein the pattern of pointer movement is a linear oscillation motion.

5. The apparatus of claim 1, wherein the analysis engine is to process the movement data after a period of inactivity.

6. The apparatus of claim 1, wherein the rendering engine is to highlight the pointer upon receiving the command.

7. The apparatus of claim 6, wherein the rendering engine is to increase brightness of a region surrounding the pointer.

8. The apparatus of claim 6, wherein the rendering engine is to decrease brightness outside of the region surrounding the pointer.

9. A method comprising:
displaying an image having a pointer, wherein the pointer is to blend with a background;
receiving user input via a pointer input device;
determining whether the user input represents a command to locate the pointer within the background; and
rendering an applet window upon receiving the command, wherein the applet window provides a location of the pointer.

10. The method of claim 9, wherein determining whether the user input represents the command comprises identifying a pattern of pointer movement.

11. The method of claim 10, wherein determining whether the pattern of pointer movement is a circular motion.

12. The method of claim 9, wherein receiving user input comprises receiving user input after a period of inactivity.

13. The method of claim 9, further comprising highlighting the pointer upon receiving the command.

14. A non-transitory machine-readable storage medium encoded with instructions executable by a processor, the non-transitory machine-readable storage medium comprising instructions to:
render an image to a display, wherein the image includes a pointer blended into a background;
receive user input via an input interface;
identify motions from the user input that represent a command to locate the pointer within the background;
render an applet window upon receiving the command; and
provide a location of the pointer within the applet window.

15. The non-transitory machine-readable storage medium of claim 14, further comprising instructions to highlight the pointer upon receiving the command.
